(19) United States
(12) Patent Application Publication
(10) Pub. No.: US 2002/0112632 A1
(43) Pub. Date: Aug. 22, 2002

(54) Method for supporting sensitive workpieces during processing

(75) Inventor: Aurel Faibish, Sitriya (IL)

Correspondence Address: GREER, BURNS & CRAIN LTD, Suite 2500, 300 S. Wacker Drive, Chicago, IL, 60606, US

(73) Assignee: CREO LTD

(21) Appl. No.: 09/789,905

(22) Filed: Feb. 21, 2001

(51) Int. Cl. B23Q 7/00

(52) U.S. Cl. 101/474

(57) ABSTRACT

A method of supporting an object having an even contact surface during manufacturing operations, by urging it to a rigid substrate, the contact surface facing a supporting surface of said substrate, for use in an environment containing particles that are likely to be entrapped between the object and the substrate. The method includes provision of a supporting surface in the form of a plurality of bulges disposed on the substrate with depressions therebetween. The bulges have crests with rounded profile enabling the entrapped particles to fall into the depressions, thereby reducing the probability of causing mechanical damage to the object and/or of a faulty manufacturing operation on the object.

### FIELD OFF THE INVENTION

This invention relates to supports for holding a workpiece during its fabrication and, more particularly, to supports for workpieces with sensitive surface, such as panels processed in printing or imaging.

### BACKGROUND OF THE INVENTION

Through the fabrication processes of a double-sided panel or other workpiece like a printing plate, chip or wafer, printed circuit board (PCB) or printed wiring board (PWB) etc., there are operations that are performed separately on each of the two surfaces of the panel. In order to enable automated and accurate processing operation to be performed on such panel, it must be positively positioned and securely fixed to a relatively rigid substrate. When positioned in such a manner, the panel faces the substrate with its one, contact surface, while another, working surface is subjected to the processing operation. When the panel is a relatively thin object which does not retain its planarity while being disposed on the substrate, it must be smoothed, for example by a rubber-coated roller pressing the panel, to fit the shape of the substrate. Then, a negative air pressure is created between the panel and the substrate in order to fix the panel securely onto the substrate. The forces between the contact surfaces, resulting from the smoothing operation and the negative pressure, are controlled to be smaller than the scratch resistance of the contact surface of the panel. However, only average forces are controlled, accounting for the applied working forces, pressures and total contact surface area, while local forces acting on local contact areas are uncontrollable.

During successive fabrication steps of the panel, there always occurs disintegration of the construction material, especially when the panel is made of a composite material such as laminated glass epoxy, and small particles of this material cling to the surfaces of the substrate and/or of the panel. This is an inherent phenomenon of the fabrication process that can hardly be avoided. Also, particles created during the processing of other panels as well as during various machine movements, remain in the manufacture environment and some of them get attached to the panel Even in a controlled environment there are dust and contamination particles brought in by the personnel and materials that fall on the substrate attracted by its static electrical charge.

A particle may sometimes originate from a glass fiber, steel chip or the like and, therefore, may be very hard. FIG. 1 illustrates such a particle 10 when trapped. between the surface of the substrate 12 and the contact surface 13 of the panel 14 that is supported by the substrate. Due to its small size and irregular shape, the particle 10 has a very small contact area 16 with the panel contact surface. Such a particle also lifts the panel locally off the surface of the substrate so that the reaction to the urging pressure P_{urge} is distributed over the small area 16 and, therefore, high local pressure is developed, which can surpass the scratch resistance and damage the panel. Due to the local raising-up of the panel, a manufacture operation on the working surface 18 may fail.

### SUMMARY OF THE INVENTION

In accordance with the present invention, there is provided a method of supporting a workpiece with a flat and scratch-sensitive contact surface during manufacturing operations, by urging it to a rigid substrate, where the contact surface of the workpiece faces a supporting surface of the substrate. The method includes provision of a supporting surface on the substrate, comprising a plurality of bulges with depressions therebetween. The bulges have crests with rounded profile that enables a particle entrapped between the workpiece and the substrate to fall into a depression, and the depth and the width of the depressions are such as to accommodate the particle at least partially. This structure reduces the probability of causing mechanical damage to the workpiece and/or of a faulty manufacturing operation on the same that may cause resection of the workpiece.

The bulges preferably are in the form of elongated ridges that may be arranged in various patterns on the substrate. The patterns may be formed by processing the substrate surface itself or by attaching a layer of material with preformed ridges.

The method of the present invention is especially advantageous in the production of printed circuit boards and printed wiring boards, when processed by imaging or printing operations. It may be used for other workpieces of any shape having at least one flat sensitive surface.

### BRIEF DESCRIPTION OF TIME DRAWINGS

In order to understand the invention and to see how it may be carried out in practice, a number of embodiments will now be described, by way of non-limiting example only. with reference to the accompanying drawings, in which:

FIG. 1 is a schematic sectional view showing a hard particle trapped under a flat panel on a conventional substrate;

FIG. 2A is a schematic sectional view of a flat panel held on a substrate according to the present invention;

FIG. 2B shows an enlarged detail B of FIG. 2A;

FIG. 3 shows a regular orthogonal network pattern of ridges on a substrate according to one embodiment of the present invention;

FIG. 4 shows a helical pattern of ridges wound on a drum substrate according to another embodiment of the present invention;

FIG. 5 shows a wave-like pattern of ridges on a substrate according to a further embodiment of the present invention; and.

FIG. 6 shows a random pattern of straight ridges on a substrate according to a still further embodiment of the present invention.

### DETAILED DESCRIPTION OF THE INVENTION

According to the present invention, as illustrated by FIG. 2A, a protective supporting surface 20 is provided on a substrate 28 for the support of a panel (workpiece) 14 having a contact surface 13. The protective surface 20 is uneven, having the form of a plurality of bulges 22 and depressions 24 remaining therebetween. Preferably, the bulges are in the form of elongated ridges, with crests 26 having rounded profiles.

As seen in FIGS. 2A and 2B, the total contact area between the contact surface 13 of the panel 14 and the crests 26 of the bulges 24 is considerably smaller than the nominal area of the panel contact surface 13 projected onto the substrate. 28. Moreover, as shown in FIG. 2B, the local pressure is not quite evenly distributed across each zone of contact. Thus, the local pressures P_{local} on the contact surface 13 of the panel are a few times larger than the uniformly distributed urging pressure P_{urge} However, the appropriate selection of the profile form and of tie width of the depressions allows average local pressures P_{local} to be controlled and kept well below the scratch resistance of the panel. In particular, in operation, with the supporting surface 20 designed according to the present invention, a particle that may be trapped between the panel 14 and the substrate 28, as shown in FIG. 2A, may behave in one of the following ways:

1. A particle 30 may originally appear to be entirely accommodated in the depression 24 and, being smaller than tile depression, not touch the panel at all.

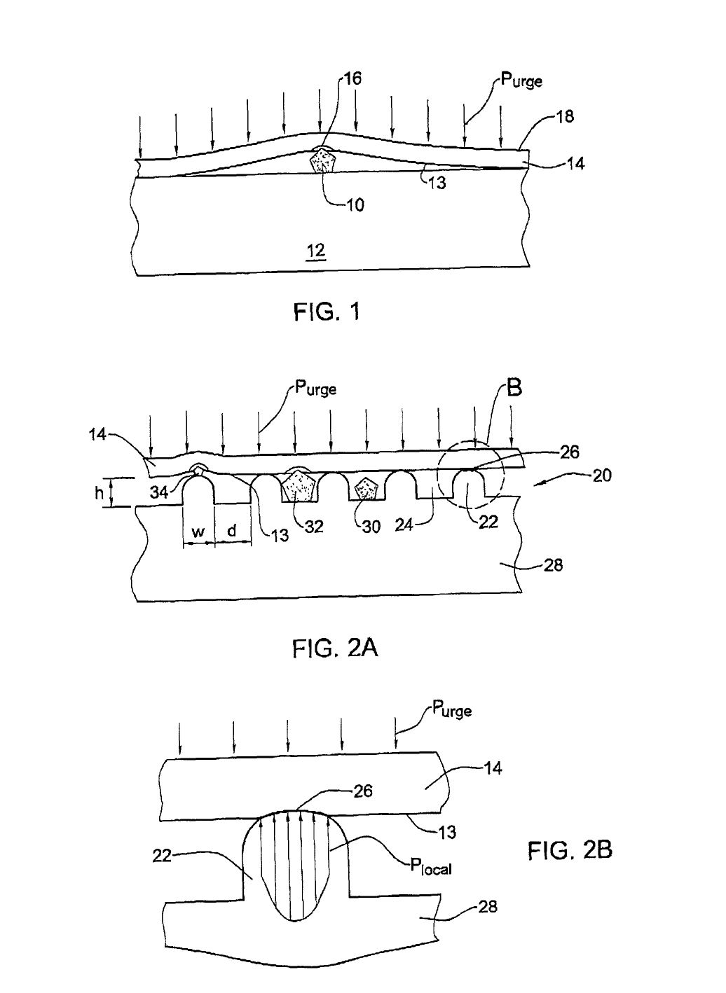

2. A particle 32 may originally appear to be not entirely accommodated in the depression having a width or height greater than that of the depression. In this case, the particle 32 will, contact the panel but the local pressure will be smaller than the pressure that would have been created if such a particle were trapped between a conventional substrate and the panel, as shown in FIG. 1.

3. A particle such as particle 30 or 32, may originally be disposed totally on top of the bulge 22 but will most probably be pushed off the side of the bulge into a depression of the substrate and will behave in either of die above ways.

4. In the least probable case, if a particle 34 remains on the bulge 22, the local pressure will be about the same as die pressure that would have been created by such a particle trapped between smooth surfaces of the substrate and the panel.

The statistical probability of a particle falling into each of the above cases is affected by the height, crest profile shape and spacing of the bulges and, therefore, may be controlled through the design and material selection of the protective surface.

The protective supporting surface is preferably designed as a combination of ridges with uniform height disposed on a basic surface of the substrate. The protective surface may also be fabricated on a separate interface sheet and then attached to the substrate.

The following criteria are to be considered in the design of a protective surface according to the present invention:

the ratio of the contact area of the ridges to the nominal area of the contact surface, which should ensure that local pressures are at least an order of magnitude lesser than the scratch resistance of the sensitive contact surface of the workpiece.

the ridge width w and the shape of their crests and their radii should be such as, on the one hand, to yield more uniform distribution of local pressures in the contact area between the supported workpiece and the ridge (see FIG. 2B), and on the other hand, to increase the probability for an entrapped particle to slip off a ridge into a depression;

the ridge spacing d and ridge height h should be such as to accommodate most of particles, but they should meet the condition to avoid deflection of the workpiece that would cause, e.g. in the case of printing operation, distortion of the pattern imaged on the panel.

In practice, it is preferable to have the ridge spacing d larger than the ridge width w, in order to accommodate most of tie contaminating particles.

In the manufacture of printing plates, chips, wafers, PCB or PWB, typical particles have dimensions between 3 to 50 μm. A protective supporting surface suitable for such manufacture should preferably have ridges with crest radius of curvature at least 0.1 mm, especially at the points of maximum height. The depression profile is preferably about 0.1 mm deep.

The experiments show that the use of protective supporting surfaces according to the present invention, allow to reduce rejection of PCB-s due to their backside scratches by a factor of 3.

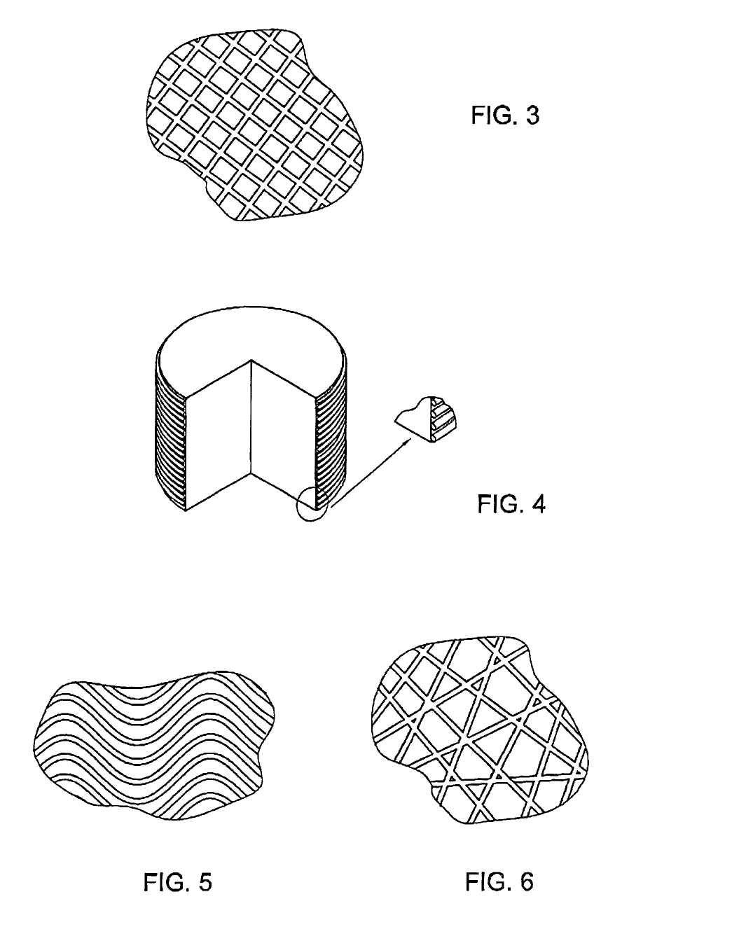

Examples of protective supporting surfaces in accordance with the present invention are presented below with reference to FIGS. 3 to 6.

FIG. 3 illustrates a layer of protective media in the form of a. Teflon sheet having a smooth surface on one side and a network of protruding orthogonal ridges on the other side. The ridges may be glass fibers that are overcoated with Teflon. The Teflon sheet may be of the type 216AP with adhesive back TY, made by Tygaflor company in the UK. The sheet is attached with its adhesive surface to the surface of the substrate. The sheet is flexible and may be attached either to a flatbed substrate or to a rotary drum substrate. The sheet also may be cut into several pieces for the use as a protective surface of the present invention to support each processed panel, whereby more than one panel may be processed on the same substrate. Such sheets are easily replaceable by peeling them off the substrate when they become worn or dirty. Due to the Teflon overcoat, the ridges on the sheets are softer than the substrate and their flexibility contributes to a better distribution of the pressure, which prevents or reduces the damage to the panel whenever confronted by a particle.

The pattern of FIG. 3 may be also obtained by spreading a Nylon net or a domestic fly net having 0.5×0.5 mm up to 1.5×1.5 mm openings on the substrate.

FIG. 4 illustrates a protective supporting surface on a rotary drum substrate. The surface is obtained by helically winding a 0.2-0.4 mm. diameter Nylon fishing line around the drum, the line forming the ridges.

FIG. 5 illustrates a pattern of wave-like protrusions embossed on a stainless steel sheet, which may be mounted by mechanical clamps onto the substrate.

The pattern of the ridges or grooves on the substrate surface may have also irregular or random character, as shown in FIG. 6.

A protective supporting surface in accordance with the method of the present invention may be created by processing the surface of the substrate rather than using a separable media. Ridges on this surface may be obtained by cutting grooves thereon or by electrochemical machining that relieves material in a network shape or by vibration rolling. In this manner, a textured protective surface may be formed by a network of continuous grooves with protruding isles therebetween, as opposed to the network of ridges.

Still another kind of protective supporting surface may be obtained by applying to the substrate surface a non-smooth paint, for example of orange-peel texture, or by coating the surface with non-smooth texture coating.

1. A method of supporting an object having an even contact surface by urging it to a rigid substrate during a manufacturing operation in an environment containing particles that are likely to be entrapped between said object and said substrate, said method including provision on said substrate of a supporting surface in the form of a plurality of bulges disposed on said substrate with depressions therebetween, said bulges having crests with rounded profile enabling at least a part of said entrapped particles to fall into said depressions, thereby reducing the probability of causing mechanical damage to said object and/or of a faulty manufacturing operation on said object.

2. A method according to claim 1, wherein the depth and the width of said depressions are such as to at least partially accommodate most of said particles.

3. A method according to claim 1, wherein said supporting surface of said substrate is formed as a separate interfacing element attached to said substrate.

4. A method according to claim 3, wherein said interfacing element includes a layer of adhesive material.

5. A method according to claim 3, wherein said separate interfacing element is made of material which is softer than said substrate.

6. A method according to claim 2, wherein said object is a layer of a printed circuit board (PCB) or of a printed wiring board (PWB).

7. A method according to claim 2, wherein said substrate is a rotary drum of an imaging or a printing machine and said object is flexible.

8. A method according to claim 2, wherein said substrate is a flat bed of an imaging or a printing machine.

9. A method according to claim 1, wherein said bulges are in the form of elongated ridges.

10. A method according to claim 9, wherein said elongated ridges form a regular network on the substrate surface.

11. A method according to claim 10, wherein said network is obtained by using a mesh attached to the substrate surface.

12. A method according to claim 9, wherein said elongated ridges form a pattern of continuous straight or curved lines running without intersections on the substrate surface.

13. A method according to claim 12, wherein said pattern is formed by laying a continuous fiber or wire on the surface of said substrate.

14. A method according to claim 13, wherein the substrate is a body of rotation and said pattern is formed by winding a thread or wire along a helical line over said body.

15. A method according to claim 1, wherein the rounded profiles of said crests have at least 0.1 min radius.

16. A method according to claim 1, wherein said depressions are in the form of elongated grooves.

17. A method according to claim 16, wherein said elongated grooves form a network on the substrate surface.

18. A method according to claim 17, wherein said network form a texture on the substrate surface, similar to orange-peel texture.

19. A method according to claim 1, wherein said bulges and depressions are created by processing said supporting surface of said substrate.
